(19) United States
(12) Patent Application Publication
(10) Pub. No.: US 2012/0274765 A1
(43) Pub. Date: Nov. 1, 2012

(54) APPARATUS FOR DETERMINING THE LOCATION OF A POINTER WITHIN A REGION OF INTEREST

(75) Inventors: Chi Man Charles Ung, Calgary (CA); David Kenneth Booth, Calgary (CA); Stephen Worthington, Calgary (CA); Roberto A.L. Sirotich, Calgary (CA); Mark Andrew Fletcher, Calgary (CA); Holly Wytrykush, Calgary (CA)

(73) Assignee: SMART TECHNOLOGIES ULC, Calgary (CA)

(21) Appl. No.: 13/407,285

(22) Filed: Feb. 28, 2012

Related U.S. Application Data
(63) Continuation-in-part of application No. 11/762,198, filed on Jun. 13, 2007.
Application No. 11/762,198 is a division of application No. 10/681,330, filed on Oct. 9, 2003, now Pat. No. 7,274,356.

(51) Int. Cl. H04N 7/18

(52) U.S. Cl. 348/143; 348/E07.085

(57) ABSTRACT

An apparatus for detecting a pointer within a region of interest comprises a first reflective element extending along a first side of the region of interest and reflecting light towards the region of interest. The first reflective element comprises at least two generally parallel bands thereon, the bands at least comprising a retro-reflective band and a reflective band. A second reflective element extends along a second side of the region of interest and reflects light towards the region of interest, the second side being joined to the first side to define a first corner. The second reflecting element comprises at least two generally parallel bands thereon, the bands at least comprising a retro-reflective band and a reflective band. At least one imaging device captures images of the region of interest including reflections from the reflective and retro-reflective bands of the first and second reflective elements. At least one illumination source is positioned adjacent to the at least one imaging device and directs light across the region of interest towards the first and second reflective elements.

### CROSS-REFERENCE TO RELATED APPLICATIONS

This application is a continuation-in-part of U.S. patent application Ser. No. 11/762,198 filed on Jun. 13, 2007, which is a divisional of U.S. patent application Ser. No. 10/681,330 filed on Oct. 9, 2003, now issued as U.S. Pat. No. 7,274,356, the entire contents of which are incorporated herein by reference.

### FIELD OF THE INVENTION

The present invention relates to an apparatus for determining the location of a pointer within a region of interest.

### BACKGROUND OF THE INVENTION

Interactive input systems are well known in the art and typically comprise an input or touch surface on which contacts are made using a pointer in order to generate user input. Pointer contacts with the touch surface are detected and are used to generate corresponding output depending on areas of the touch surface where the pointer contacts are made. There are basically two general types of interactive input systems available and they can be broadly classified as “active” and “passive” interactive input systems.

Active interactive input systems allow a user to generate user input by contacting the touch surface with a special pointer that usually requires some form of on-board power source, typically batteries. The special pointer emits signals such as infrared light, visible light, ultrasonic frequencies, electromagnetic frequencies, etc. that activate the touch surface.

Passive interactive input systems allow a user to generate user input by contacting the touch surface with a passive pointer and do not require the use of a special pointer in order to activate the touch surface. A passive pointer can be a finger, a cylinder of some material, or any suitable object that can be used to contact some predetermined area of interest on the touch surface.

Passive interactive input systems provide advantages over active interactive input systems in that any suitable pointing device, including a user's finger, can be used as a pointer to contact the touch surface. As a result, user input can easily be generated. Also, since special active pointers are not necessary in passive interactive input systems, battery power levels and/or pointer damage, theft, or misplacement are of little concern to users.

International PCT Application No. PCT/CA01/00980 filed on Jul. 5, 2001 and published under No. WO 02/03316 on Jan. 10, 2002, assigned to SMART Technologies ULC of Calgary, Alberta, Canada, assignee of the subject application, discloses a camera-based interactive input system comprising a touch screen that includes a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking generally across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer relative to the touch surface using triangulation. The pointer location data is conveyed to a computer executing one or more application programs. The computer uses the pointer location data to update the computer-generated image that is presented on the touch surface. Pointer contacts on the touch surface can therefore be recorded as writing or drawing or used to control execution of application programs executed by the computer.

Although the above interactive input system works extremely well, the use of four digital cameras and associated digital signal processors to process image data captured by the digital cameras makes the touch system hardware intensive and therefore, increases the costs of manufacture. This of course translates into higher costs to consumers. In some environments where expense is of a primary concern, less expensive interactive input systems are desired.

A camera-based interactive input system having reduced hardware has been considered. For example, U.S. Pat. No. 5,484,966 to Segen discloses an apparatus for determining the location of an object within a generally rectangular active area. The apparatus includes a pair of mirrors extending along different sides of the active area and oriented so that the planes of the mirrors are substantially perpendicular to the plane of the active area. The mirrors are arranged at a 90 degree angle with respect to one another and intersect at a corner of the active area that is diagonally opposite a detecting device. The detecting device includes a mirror and a charge coupled device (CCD) sensor and looks along the plane of the active area. A processor communicates with the detecting device and receives image data from the CCD sensor.

When a stylus is placed in the active area, the detecting device sees the stylus directly as well as images of the stylus reflected by the mirrors. Images including the stylus and stylus reflections are captured by the detecting device and the captured images are processed by the processor to detect the stylus and stylus reflections in the captured images. With the stylus and stylus reflections determined, the location of the stylus within the active area is calculated using triangulation.

Although this apparatus reduces hardware requirements since only one optical sensing device and processor are used, problems exist in that at certain locations within the active area, namely along the side edges and adjacent the corner diagonally opposite the detecting device, resolution is reduced. As will be appreciated, an interactive input system that takes advantage of reduced hardware requirements yet maintains high resolution is desired.

It is therefore an object to provide a novel apparatus for determining the location of a pointer within a region of interest.

### SUMMARY OF THE INVENTION

Accordingly, in one aspect there is provided an apparatus for detecting a pointer within a region of interest comprising a first reflective element extending along a first side of said region of interest and reflecting light towards said region of interest, said first reflective element comprising at least two generally parallel bands thereon, said bands at least comprising a retro-reflective band and a reflective band, a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band, at least one imaging device capturing images of said region of interest including reflections from the reflective and retro-reflective bands of said first and second reflective elements, and at least one illumination source positioned adjacent to said at least one imaging device, said at least one illumination source directing light across said region of interest towards said first and second reflective elements.

According to another aspect there is provided an apparatus for detecting a pointer within a region of interest comprising a first reflective element extending along a first side of said region of interest and reflecting light towards said region of interest, said first reflective element comprising at least two generally parallel bands thereon, said bands at least comprising a retro-reflective band and a reflective band, a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band, at least one imaging device capturing images of said region of interest and reflections from said first and second reflective elements, said at least one imaging device having an active pixel sub-array and said first and second reflective elements being configured to aim reflected light towards said active pixel sub-array, and at least one illumination source positioned adjacent to said at least one imaging device, said at least one illumination source directing light across said region of interest and towards said first and second reflective elements.

According to yet another aspect there is provided an apparatus for detecting a pointer within a region of interest comprising a generally rectangular touch surface defining said region of interest, a first reflective element extending along a first side of said region of interest and reflecting light towards said region of interest, said first reflective element comprising at least two generally parallel bands thereon, said bands at least comprising a retro-reflective band and a reflective band, a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band, a detecting device detecting said pointer within said region of interest contrasting with a background provided by the retro-reflective bands of said first and second reflective elements, the detecting device also detecting said pointer and reflections of said pointer contrasting with a background provided by the reflective bands of said first and second reflective elements, and determining the location of said pointer within said region of interest, and at least one illumination source positioned adjacent said to said detecting device, said at least one illumination source directing light across said region of interest and towards said first and second reflective elements.

According to still yet another aspect there is provided an apparatus for detecting a pointer within a region of interest comprising a first reflective element extending along a first side of said region of interest and reflecting light towards said region of interest, said first reflective element comprising at least two generally parallel bands thereon, said bands at least comprising a retro-reflective band and a reflective band, at least two imaging devices positioned adjacent to opposing corners of a second side of said region of interest, said second side opposite said first side, said at least two imaging devices capturing images of said region of interest including reflections from the reflective and retro-reflective bands of said first reflective element, and at least two illumination sources directing light across said region of interest towards said first reflective element.

### BRIEF DESCRIPTION OF THE DRAWINGS

Embodiments will now be described more fully with reference to the accompanying drawings in which:

FIG. 1 is a schematic view of an apparatus for determining the location of a pointer within a region of interest.

FIG. 2 is a plan view of an assembly forming part of the apparatus of FIG. 1.

FIG. 3 is another plan view of the assembly of FIG. 2 showing the region of interest encompassed by the assembly including an active area bounded by margins.

FIG. 4 is a side view, partly in section, of a portion of the assembly of FIG. 2, showing a mirror assembly.

FIG. 5 is a schematic block diagram of an imaging device forming part of the apparatus of FIG. 1.

FIG. 6 is a plan view showing a pointer within the region of interest and resulting pointer reflections.

FIG. 7 is an image captured by the imaging device of FIG. 5.

FIGS. 8a to 8d are plan views showing a pointer within the region of interest at locations resulting in pointer image merging.

FIGS. 9a to 9d are illustrations showing determination of the margins within the region of interest.

FIGS. 10 to 13 show captured images, local pointer difference images, horizontal intensity profiles (HIPs) and local pointer binary images.

FIGS. 14 and 15 are plan views of an alternative embodiment of an apparatus for determining the location of a pointer within a region of interest.

FIGS. 16 and 17 are plan views of yet another alternative embodiment of an apparatus for determining the location of a pointer within a region of interest.

FIGS. 18 to 20 are partial perspective, partial sectional side elevational and side elevational views, respectively, of alternative mirror assemblies.

FIG. 21 is a plan view of yet another embodiment of an apparatus for determining the location of a pointer within a region of interest.

FIG. 22a is a side view of an alternative embodiment of an illuminated bezel.

FIG. 22b is a top plan view of the illuminated bezel of FIG. 22a.

FIG. 23 is a schematic view of still yet another alternative embodiment of an apparatus for determining the location of a pointer within a region of interest.

### DETAILED DESCRIPTION OF THE EMBODIMENTS

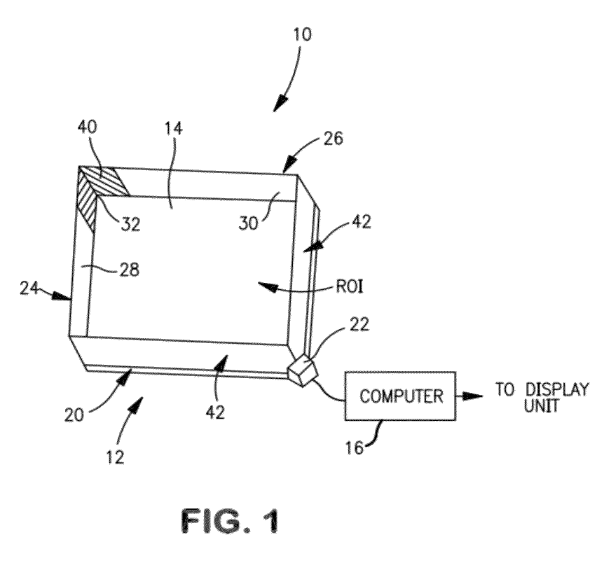

Turning now to FIGS. 1 to 3, an apparatus for determining the location of a pointer within a region of interest is shown and is generally identified by reference numeral 10. In this embodiment, apparatus 10 is in the form of an interactive input system and is disposed over the display screen of a display unit such as for example, a plasma television, a liquid crystal display (LCD) panel, a front or rear projection screen or other suitable display unit (not shown). As can be seen, apparatus 10 comprises a generally rectangular assembly 12 encompassing a region of interest ROI and surrounding a generally transparent touch surface 14 that overlies the display screen. Assembly 12 communicates with a general purpose computing device 16 such as for example a personal computer executing one or more application programs. The general purpose computing device 16 uses pointer data generated by the assembly 12 to update computer-generated images that are presented on the display screen of the display unit. Pointer contacts on the touch surface 14 can therefore be recorded as writing or drawing or used to control execution of application programs executed by the general purpose computing device 16.

Assembly 12 comprises a frame 20 supporting an imaging device 22 adjacent one corner of the touch surface 14. The imaging device 22 has a field of view that looks generally across the plane of the touch surface 14 and is oriented so that its optical axis generally forms a 45 degree angle with adjacent sides of the touch surface 14. A pair of mirrors 24 and 26 is also supported by the frame 20. Each mirror 24, 26 extends along a different side of the touch surface 14 and is oriented so that the plane of its reflecting surface 28, 30 is generally perpendicular to the plane of the touch surface 14. The mirrors 24 and 26 are thus arranged at generally a 90 degree angle with respect to one another and intersect at a corner 32 of the touch surface 14 that is diagonally opposite the imaging device 22. A gap 40 is provided between the two mirrors 24 and 26 at the corner 32 to define a non-reflecting area or region.

The frame 20 also supports illuminated bezels 42 that extend along the remaining two sides of the touch surface 14. The illuminated bezels 42 direct light such as for example infrared light towards the reflecting surfaces of the mirrors 24 and 26. The light is in turn reflected back towards the imaging device 22 so that the imaging device 22 effectively sees bright bands of infrared backlighting. A band of infrared illumination is also directed towards the imaging device 22 by an illuminated bezel 42 disposed within the gap 40. The imaging device 22 therefore observes a generally continuous bright band of infrared illumination when no pointer is located within the region of interest ROI. However, when the imaging device 22 acquires an image and a pointer P is located within the region of interest ROI, the pointer P occludes reflected illumination and appears to the imaging device 22 as a black or dark object against a white or bright background. The infrared illuminated bezels 42 are similar to those described in U.S. Pat. No. 6,792,401 entitled “Illuminated Bezel And Touch System Incorporating the Same” to Akitt, et al., issued on Dec. 6, 2005 and assigned to SMART Technologies ULC, the content of which is incorporated herein by reference in its entirety. Accordingly, specifics of the illuminated bezels 42 will not be described further herein.

As best shown in FIG. 3, the region of interest ROI is bounded by bottom, top, left and right margins M_{bot}, Mₜₒₚ, M_{left}, M_{right} respectively to define an active area 34. The height of the region of interest ROI above the touch surface 14 is determined by the geometry of the mirrors 24 and 26, the illuminated bezels 42 and the field of view of the imaging device 22. In this embodiment, each of the margins has a one-inch width giving the active area 34 a diagonal dimension equal to 72 inches. The size of the gap 40 is a function of the size of the touch surface 14, the widths of the margins and the size of the pointer used to contact the touch surface 14. Further specifics concerning the manner by which the gap and margin sizes are calculated will be described herein.

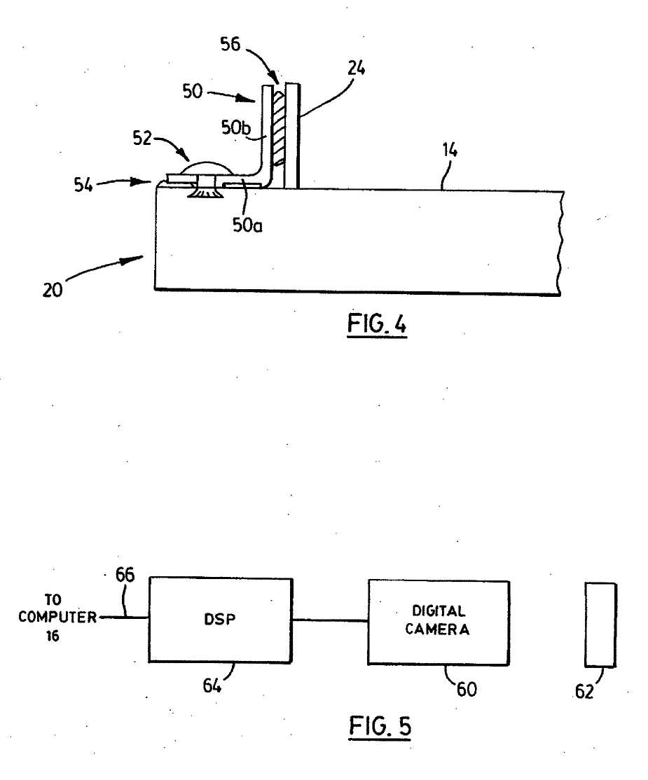

Each mirror 24, 26 is supported on the frame 20 by a right angle extruded bracket 50 as shown in FIG. 4. Each bracket 50 is secured to the frame 20 by fasteners 52 that pass through the leg 50a of the bracket 50 that overlies the frame 20. Adhesive 54 is placed between the leg 50a and the frame 20 to secure further the bracket 50 to the frame and inhibit the bracket from moving relative to the frame even if the fasteners 52 loosen. The adhesive 54 also acts as a filler. The mirror is secured to other leg 50b of the bracket 50 by adhesive 56 to inhibit relative movement between the bracket 50 and the mirror. In this embodiment, GE Silicone SE1124 All Purpose Silicone Seal is used as the adhesive.

The reflective surfaces 28 and 30 of the mirrors 24 and 26 are generally planar and are oriented so that the bands of backlight illumination provided by the illuminated bezels 42, when reflected by the mirrors, are directed towards an active pixel sub-array of the imaging device 22. Orienting the mirrors 24 and 26 so that the reflective surfaces achieve this desired function maintains the resolution of the apparatus 10 allowing pointer hover above and pointer contact with the touch surface 14 to be accurately determined. To align the mirrors, during assembly, adhesive 56 is placed along the leg 50b of each bracket 50 and the mirrors are set in place. While the adhesive 56 is setting, the tilt of each mirror is adjusted until the backlighting reflected by the reflective surface is directed toward the active pixel sub-array of the imaging device 22. Once the adhesive 56 sets, the mirrors 24 and 26 are securely held by the adhesive 56 thereby to maintain their orientation.

The imaging device 22 is best seen in FIG. 5 and comprises a high resolution 1280×1024 CMOS digital camera 60 such as that manufactured by National Semiconductor under model No. LM9638 and an associated lens 62. A digital signal processor (DSP) 64 is coupled to the digital camera 60. The digital camera 60 and DSP 64 are mounted on a common circuit board. The circuit board is positioned with respect to the touch surface 14 so that the digital camera 60 looks out across the plane of the touch surface 14. The lens 62 has a 98 degree field of view so that the entire active area 34 is within the field of view of the digital camera 60 plus 4 degrees of tolerance on either side of the region of interest ROI. The DSP 64 is also coupled to the general purpose computing device 16 via a universal serial bus (USB), an RS232 serial cable 66 or other suitable wired or wireless connection. The digital camera 60 in this embodiment is configured to have a 1280×40 active pixel sub-array allowing it to be operated to capture image frames at high frame rates (i.e., in excess of 200 frames per second).

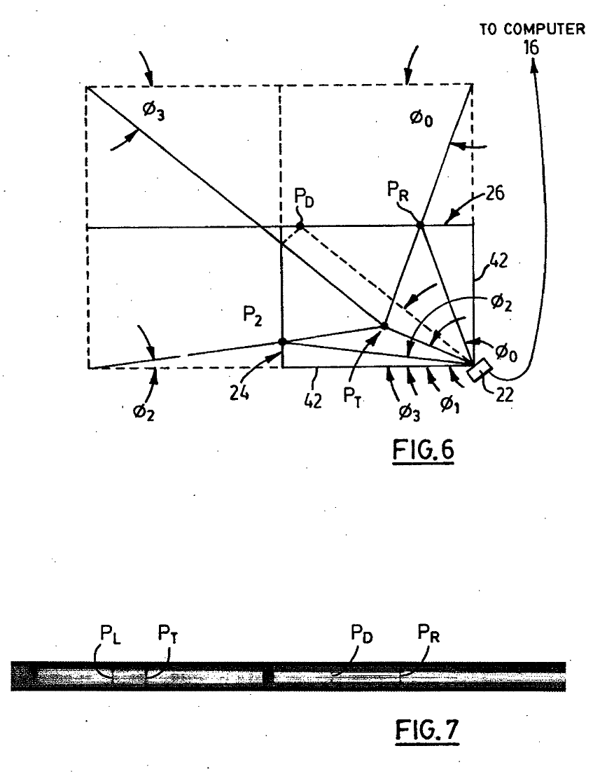

During use, when a pointer P is brought into the active area 34 of the region of interest ROI and therefore, into the field of view of the digital camera 60, the pointer P occludes the backlight illumination emitted by the illuminated bezel 42 in the gap 40 and the backlight illumination reflected by the mirrors 24 and 26. When the digital camera 60 captures an image and a pointer P is in the image, depending on the position of the pointer P, the captured image includes dark areas representing the pointer P and images or reflections of the pointer. Depending on the location of the pointer relative to the active area 34 different scenarios may occur. For example, the captured image may include dark areas representing the true pointer P_{T}, and three images of the pointer resulting from right, left and double pointer reflections P_{R}, P_{L}, P_{D} respectively or may include dark areas representing the true pointer P_{T}, and two pointer images. FIG. 6 shows the true pointer P_{T} and the pointer reflections P_{R}, P_{L}, P_{D} as seen by the digital camera 60 as a result of occluded backlight illumination and the angles Ø₀ to Ø₃ associated with the true pointer P_{T} and the pointer reflections P_{R}, P_{L}, P_{D}. FIG. 7 shows a captured image including the true pointer P_{T} and the pointer reflections P_{R}, P_{L} and P_{D}.

Although the interactive input system 10 includes only a single digital camera 60, the use of the mirrors 24 and 26 to reflect images of the pointer P towards the digital camera 60 effectively creates an interactive input system that is four (4) times as large with virtual cameras at each of its corners as shown in FIG. 6. In this case, the pointer reflections can be considered to be seen by virtual cameras with the pointer reflections in the mirrors 24 and 26 determining the positions of the virtual cameras. Angles are associated with the virtual camera images and these angles are identical to the angles Ø₀ to Ø₃ associated with the true pointer and pointer reflections.

In order to determine the position of the pointer P relative to the touch surface 14, it is necessary to distinguish between the true pointer and the various pointer reflections in the captured image. Relying on the geometry of the interactive input system 10, the following relationships between the angles Ø₁ to Ø₃ hold true. Ø₂ is less than or equal to Ø₁, which is less than or equal to Ø₀. Ø₂ is less than or equal to Ø₃, which is less than or equal to Ø₀. As a result, the outer two pointers in the captured image always correspond to angles Ø₂ and Ø₀ and the two inner pointers in the captured image always correspond to angles Ø₁ and Ø₃.

When the captured image includes four dark areas representing the true pointer P_{T}, the right pointer reflection P_{R}, the left pointer reflection P_{L} and the double pointer reflection P_{D}, distinguishing between the true pointer and the pointer reflections is a straightforward process. The dark area to the extreme left is the left pointer reflection P_{L} and the dark area to the extreme right is the right pointer reflection P_{R}. To distinguish between the true pointer P_{T} and the double pointer reflection P_{D}, i.e., the two intermediate dark areas, the column of the active pixel sub-array that contains the diagonal vertex, i.e., the midpoint of the illuminated bezel 42 within the gap 40, is determined. Once the column location of the diagonal vertex is determined, the columns of the active pixel sub-array that contain the two intermediate dark areas are determined. The distances between the columns that contain the two intermediate dark areas and the column containing the diagonal vertex are compared. Since the double pointer reflection P_{D} is always further away from the imaging device 22, the column separation between the double pointer reflection P_{D} and the diagonal vertex is always smaller than the column separation between the true pointer P_{T} and the diagonal vertex. As a result by comparing the column separation between the intermediate dark areas and the diagonal vertex, the true pointer P_{T} can be easily distinguished from the double pointer reflection P_{D}.

When the captured image includes three dark areas, the column location of the diagonal vertex is again determined and the number of dark areas on each side of the diagonal vertex area are determined. If two dark areas are to the left of the diagonal vertex and one dark area is to the right of the diagonal vertex, two scenarios are possible. In one scenario, the true pointer P_{T} is merging with the right pointer reflection P_{R}. In this case, the left dark area is the left pointer reflection P_{L} and the middle dark area is the double pointer reflection P_{D}. The right dark area includes both the true pointer P_{T} and the right pointer reflection P_{R}. The other scenario is that the double pointer reflection P_{D} is missing as a result of the non-reflective region associated with the gap 40. To determine which scenario exists, again the pointer data is processed for both scenarios and the scenario that yields a correctly triangulated location is determined to be correct. If both scenarios yield a correctly triangulated location, the position of the middle dark area relative to the diagonal vertex is determined. If the double pointer reflection Pₚ is missing, the true pointer P_{T} will be very close to the diagonal vertex.

Similarly if two dark areas are to the right of the diagonal vertex and one dark area is to the left of the diagonal vertex, two scenarios are possible. In one scenario, the true pointer P_{T} is merging with the left pointer reflection P_{L}. In this case, the right dark area is the right pointer reflection P_{R} and the middle dark area is the double pointer reflection P_{D}. The left dark area includes both the true pointer P_{T} and the left pointer reflection P_{L}. The other scenario is that the double pointer reflection P_{D} is missing as a result of the non-reflective region associated with the gap 40. To determine which scenario exists, again the pointer data is processed for both scenarios and the scenario that yields a correctly triangulated location is determined to be correct. If both scenarios yield a correctly triangulated location, the position of the middle dark area relative to the diagonal vertex is determined. If the double pointer reflection Pₚ is missing, the true pointer P_{T} will be very close to the diagonal vertex.

Knowing the true pointer P_{T} and two or more of the pointer reflections P_{R}, P_{L} and Pₚ as well as the angles Ø₀ to Ø₃, the pointer position relative to the touch surface is calculated using well known triangulation such as described in U.S. Pat. No. 6,954,197 issued on Oct. 11, 2005 for an invention entitled “Size/Scale And Orientation Determination Of A Pointer In A Camera-Based Touch System” to Morrison, et al., assigned to SMART Technologies ULC, the content of which is incorporated herein by reference in its entirety. In this example, a bounding area representing the pointer location relative to the touch surface 14 is determined and conveyed to the general purpose computing device 16.

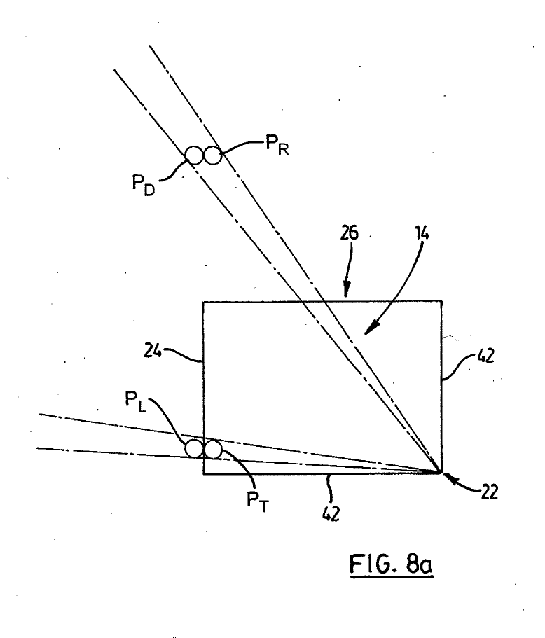

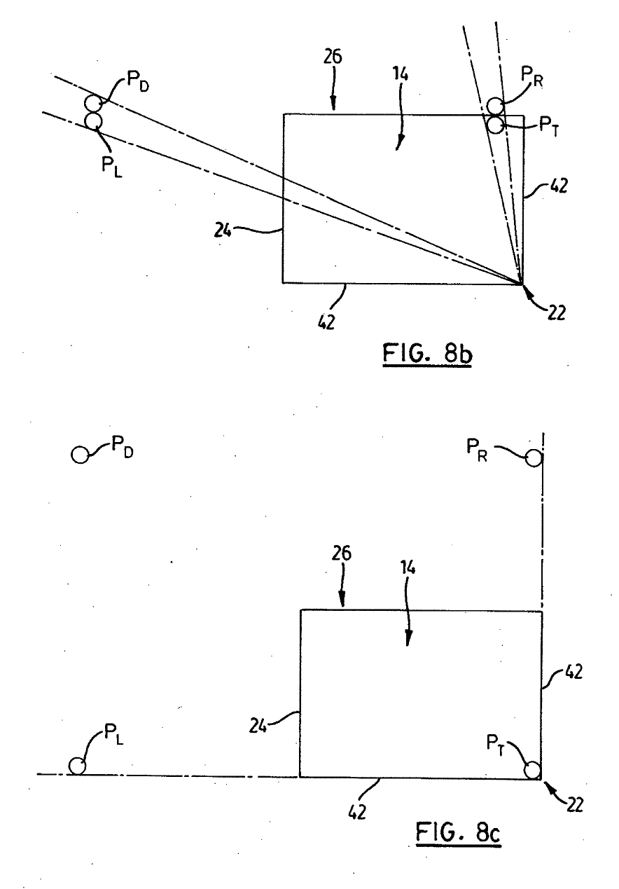

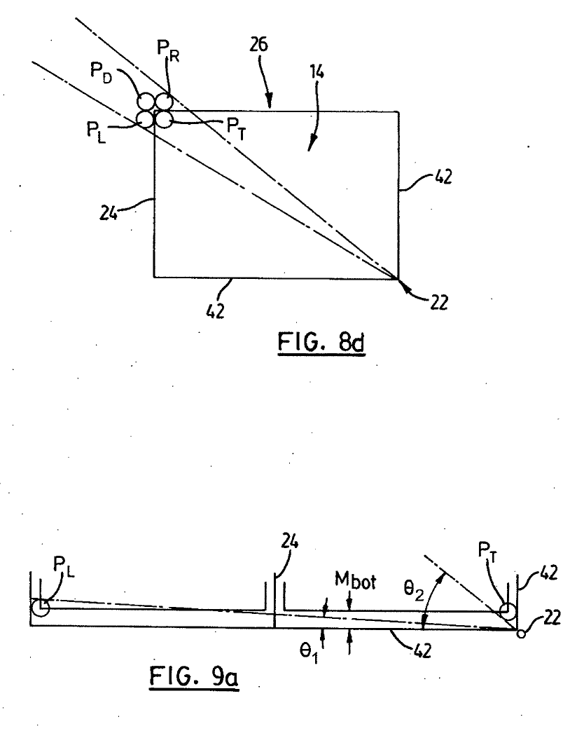

The margins are provided about the periphery of the active area 34 to avoid pointer identification ambiguity that may occur if the pointer P gets too close to the mirrors 24 and 26, too close to the imaging device 22 or too close to the diagonal vertex, i.e., corner 32. When the pointer P gets too close to the mirror 24 adjacent the illuminated bezel 42, the true pointer P_{T} and left pointer reflection P_{L} will merge and the right pointer reflection P_{R} and double pointer reflection P_{D} will merge as shown in FIG. 8a. When the pointer P gets too close to the mirror 26 adjacent the illuminated bezel 42, the true pointer P_{T} and right pointer reflection P_{R} will merge and the left pointer reflection P_{L} and double pointer reflection P_{D} will merge as shown in FIG. 8b. When the pointer P gets too close to the imaging device 22 or too close to the diagonal vertex, the true pointer P_{T} and the left, right and double pointer reflections will merge as shown in FIGS. 8c and 8d. Assuming that the active area 34 has a diagonal dimension equal to 72 inches with a 4:3 aspect ratio where the pointer can go right to the extreme edges of the active area 34 and, assuming a maximum pointer diameter equal to ¾ inch, the dimensions of the margins are determined as follows.

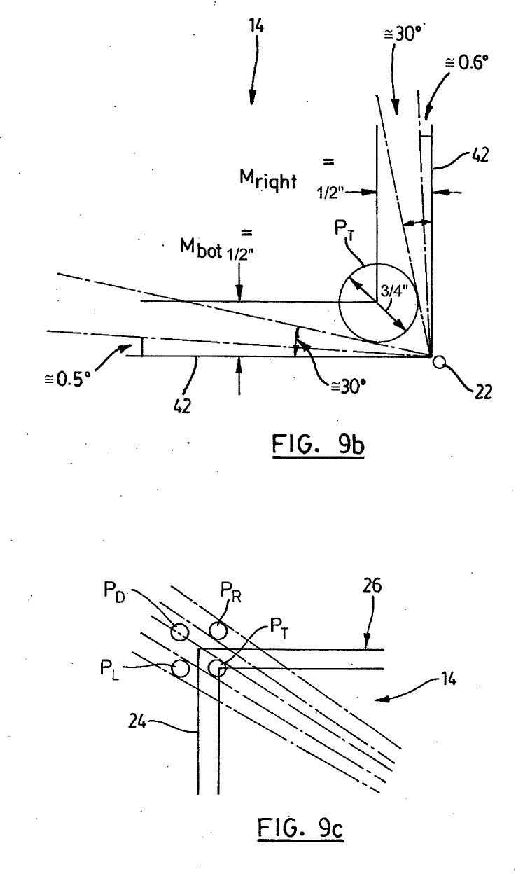

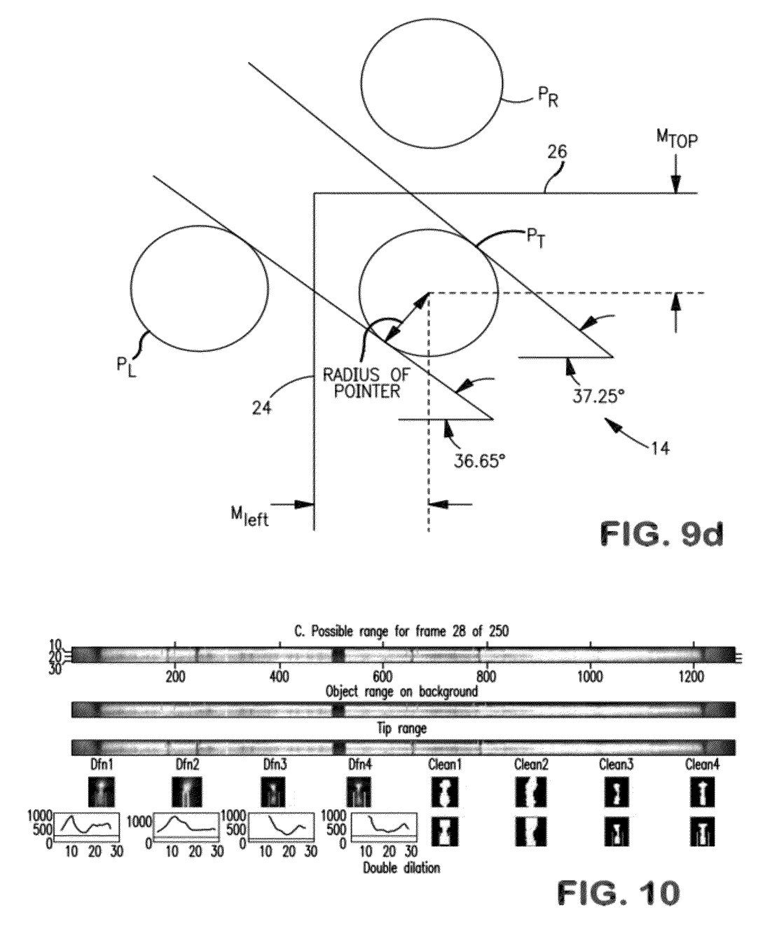

The widths of the margins M_{bot} and M_{right} are determined based on the situation where the pointer P gets too close to the imaging device 22 and are calculated as follows with reference to FIG. 9a.

When θ₂ is less than θ₁, the true pointer P_{T} and the left pointer reflection P_{L} will merge. Thus, in order to prevent merging, θ₂ must be larger than θ₁. To calculate margin M_{bot}, the smallest M_{bot} is desired while ensuring θ₂ is bigger than θ₁.

The calculation of margin M_{bot} depends on the values chosen for margins M_{left} and M_{right}. In order to simplify the calculations, assume margins M_{left} and M_{right} both have widths equal to one inch. Using standard trigonometry, it can be deduced that:

tan(θ₁)≅(M_{bot}+(pointer diameter/2))/(2×4×72/5+M_{right}+2×M_{left})

θ₁≅arctan((M_{bot}+0.375)/118.2)<1°.

Substituting the measurements given above for the apparatus 10, it can be seen that θ₁<1°. Similarly, it can be shown that:

θ₂≅90°−arctan(M_{right}/M_{bot})−arcsin((pointer diameter/2)/sqrt((M_{right})²+(M_{bot})²)).

While it is possible to solve for margin M_{bot} using analytic techniques, it is also possible to use a trial and error technique. The trial and error technique involves selecting a potential value for margin M_{bot} and computing θ₂ using the above equation. If θ₂ is larger than θ₁, then the selected margin M_{bot} is acceptable and will inhibit pointer merging. By way of example, if margin M_{bot} has a width equal to ½ inch and margin M_{right} has a width equal to 1 inch, θ₂ is 7°, which is larger than θ₁.

A similar technique can be applied to margin M_{right} and a value can be computed for a given margin M_{bot}. Consider the example shown in FIG. 9b, with margin M_{bot} and M_{right} both having widths equal to ½ inch. In this case, θ₁ for the bottom edge is 0.45 degrees and θ₁ for the right edge is 0.6 degrees. θ₂ for both cases works out to approximately 30 degrees, which clearly satisfies the condition that θ₂>θ₁ along both edges.

In order to inhibit pointer merging when the pointer P is too close to the mirrors 24 and 26 near the illuminated bezels or too close to the diagonal vertex, a margin is introduced along the left and top sides of the active area 34. The worst case generally happens at the corner 32 diagonally opposite the imaging device 22 if the mirrors intersect at that corner. As will be appreciated, if the mirrors 24 and 26 extended along the entire lengths of the touch surface sides and intersected at the corner 32, when a pointer P is positioned near the corner 32, in a captured image the true pointer P_{T} and the double pointer reflection P_{D} will merge as shown in FIG. 9c. In this case, resolution decreases since the area of the bounding area representing the pointer location relative to the touch surface 14 increases. The gap 40 between the mirrors 24 and 26 at the corner 32 is provided to eliminate the double pointer reflection P_{D} when the pointer P is near the corner 32. Specifically, for a given pointer size and a given touch surface size, the gap 40 is selected so that at no point on the touch surface 14 will the true pointer P_{T} merge with the double pointer reflection P_{D}.

Using the same dimensions as above, the angles that bound the true pointer P_{T} are 36.65° and 37.25° as shown in FIG. 9d. Using trigonometric techniques, it can be shown that:

M_{left}≧pointer radius/sin(36.65°)≧0.63″

Mₜₒₚ≧pointer radius/cos(37.25°)≧0.47″.

In practice, the separation between the true pointer and a pointer reflection should be large enough such that the imaging device 22 can resolve the difference between the true pointer and the pointer reflection. Generally, the widths of the margins are selected to be greater than the minimum widths to take into account limitations in the resolving power of the imaging device 22 as well as the fact that the pointer P may be held at an angle relative to the touch surface.

When a pointer is positioned adjacent a corner of the touch surface 14 where one of the illuminated bezels 42 and mirrors 24 and 26 meet, the true pointer and the pointer reflection from the nearest mirror merge. In this case, whenever a pointer image includes two pointer tips, the actual locations of the true pointer P_{T} and the pointer reflection are ascertained using the shape of the bounding box surrounding the merged images.

The optical axis of the digital camera 60 is also at an oblique angle with respect to the plane of the touch surface 14 so that when a pointer P is in the active area 34 of the region of interest ROI, the digital camera 60 sees the true pointer and the pointer reflections as well as reflections of the true pointer and the pointer reflections off of the touch surface 14. Pointer contacts with the touch surface 14 are determined when the true pointer and pointer reflections and their reflections off of the touch surface 14 are in contact. Pointer hover is determined when the true pointer and pointer reflections and their reflections off of the touch surface 14 are spaced apart. Further specifics of this contact detect determination are described in U.S. Pat. No. 6,947,032 to Morrison, et al., issued on Sep. 20, 2005 for an invention entitled “Touch System And Method For Determining Pointer Contacts On A Touch Surface”, assigned to SMART Technologies ULC, the content of which is incorporated herein by reference in its entirety.

Due to optical and mechanical limitations, in some instances even when a pointer is hovering over the touch surface 14, one or more of the true pointer and pointer reflections may appear to be in contact with their reflections off of the touch surface 14. To enhance contact detect, difference images are generated by subtracting current images of the true pointer and pointer reflections from the corresponding locations in a background image captured upon initialization of the apparatus 10. Then, horizontal intensity profiles (HIPs) of the difference images are combined with the captured images.

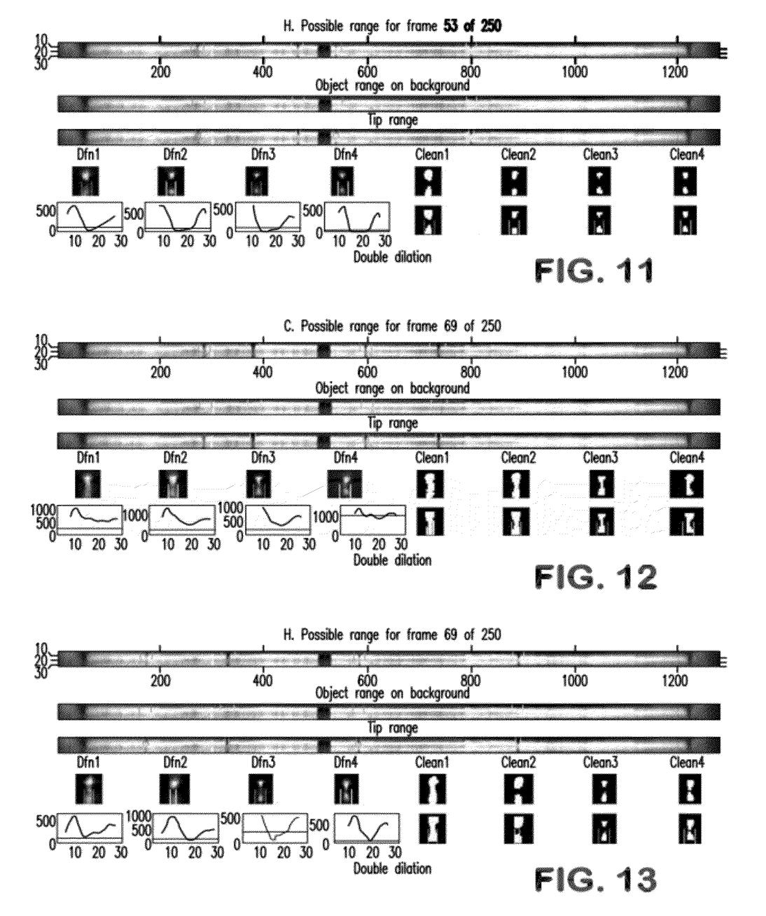

FIG. 10 shows a captured image including a true pointer and pointer reflections, four local difference images Dfn1 to Dfn4, the HIPs of the difference images together with associated threshold lines and processed binary images. The threshold lines are obtained by taking the average intensity value of the background image plus two times the standard deviation. When a pointer P is in contact with the touch surface 14, each HIP should be above its threshold line and each binary image of the pointer should be solid as shown in FIG. 10. When a pointer P is hovering above the touch surface 14, each HIP should extend below its threshold line and each binary image of the pointer should show a gap as illustrated in FIG. 11.

In some instances, an HIP and associated binary image may be inconsistent. For example, in FIG. 12, the HIP extends below its threshold line yet the binary pointer image is solid. Situations where an HIP is above its threshold yet the associated binary pointer image shows a gap can also occur. As a result, determining contact using only HIPs or binary images can yield inaccuracies. Accordingly, when any of the following two conditions are met, the pointer P is determined to be hovering over the touch surface 14; otherwise it is determined to be in contact with the touch surface:

for at least two pointers, there is a gap of the pointer in the binary image; or

for at least one pointer, the associated HIP extends below its threshold line and there is a gap of the pointer in the binary image and for at least two pointers their associated HIPs extend below their threshold lines.

It is possible that pointers may satisfy both conditions as illustrated in FIG. 13. As can be seen the pointer is hovering above the touch surface 14 and both of the above conditions are satisfied. Alternately contact states may be determined by examining the true pointer only.

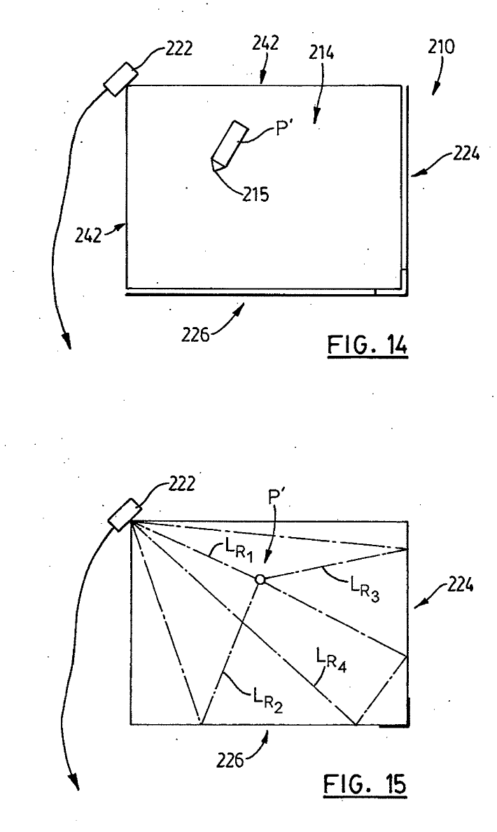

Turning now to FIGS. 14 and 15, an alternative embodiment of an apparatus for detecting a pointer within a region of interest is shown and is generally identified by reference numeral 210. In this embodiment, the illuminated bezels are replaced with non-reflective material 242 and an active pointer P′ is used to contact the touch surface 214. The active pointer includes a tip switch (not shown) and a light source 215 adjacent the tip of the active pointer. The light source 215 in this embodiment is an infrared light emitting diode (IR LED). When the tip of the active pointer P′ is brought into contact with the touch surface 214 with a threshold activation force, the tip switch is activated and the IR LED is illuminated. As a result when no pointer P′ is within the field of view of the imaging device 222, captured images are dark.

When the pointer P′ is in contact with the touch surface 214 and the pointer emits infrared light, light rays are emitted by the IR LED as shown in FIG. 15. In this case, light ray LR₁ travels directly to the imaging device 222. Light rays LR₂ and LR₃ reflect off of one of the mirrors 224 or 226 before travelling to the imaging device 222. Light ray LR₄ reflects off of both mirrors 224 and 226 before travelling to the imaging device 222. As a result, the imaging device 222 sees either three or four bright regions representing pointer images allowing the position of the pointer P′ relative to the touch surface 214 to be determined in the manner described previously. If desired, the active pointer P′ may include two LEDs of different frequencies. In this case, one of the LEDs is illuminated when the pointer P′ is out of contact with the touch surface 214 and is used to indicate hover. When the pointer P′ is brought into contact with the touch surface 214, the tip switch activates the other LED and deactivates the hover LED. As a result, light of one frequency received by the imaging device 222 represents a pointer hover condition while light of a different frequency received by the imaging device 222 represents a pointer contact condition. Illuminated bezels 42 may be provided along the sides of the touch surface 214 with the illuminated bezels being turned off when an active pointer P′ is being used and turned on when a passive pointer is being used. This of course yields an apparatus with dual passive/active pointer functionality.

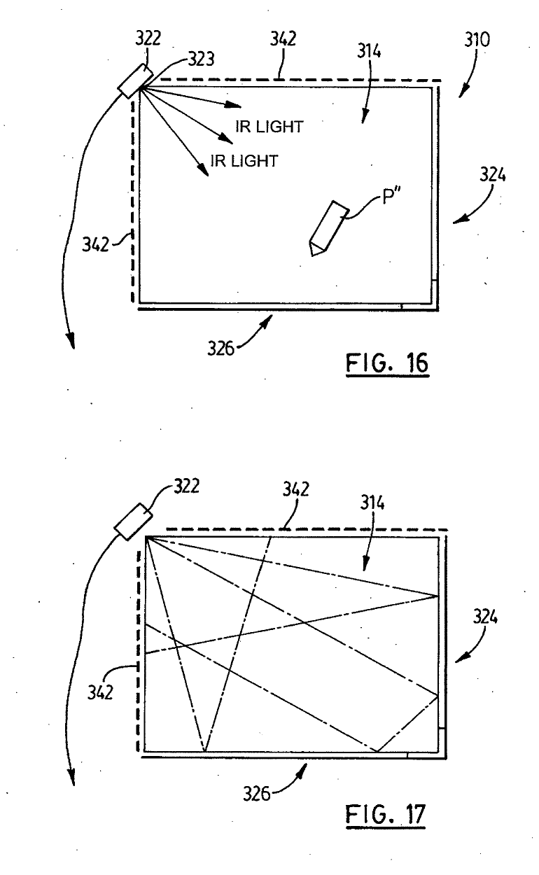

Turning now to FIGS. 16 and 17, yet another embodiment of an apparatus for detecting a pointer within a region of interest is shown and is generally identified by reference numeral 310. In this embodiment, the illuminated bezels are replaced with retro-reflectors 342. Infrared light emitting diodes (LEDs) 323 are positioned adjacent the imaging device 322 and direct infrared light into the region of interest. Light emitted by the infrared LEDs 323 travels across the touch surface 314, reflects off of one or both mirrors 324 and 326 and strikes a retro-reflector 342. The retro-reflector 342 in turn reflects the light back in the direction from which it came and thus, the reflected light is returned to the imaging device 322. As a result, when no pointer is within the field of view of the imaging device, the imaging device 322 sees a bright band. However, when a pointer P″ is brought into the region of interest, the pointer occludes light and thus, the pointer and its reflections appear in captured images as dark areas. As a result, the imaging device 322 sees either three or four pointer images allowing the position of the pointer relative to the touch surface 314 to be determined in the manner described previously.

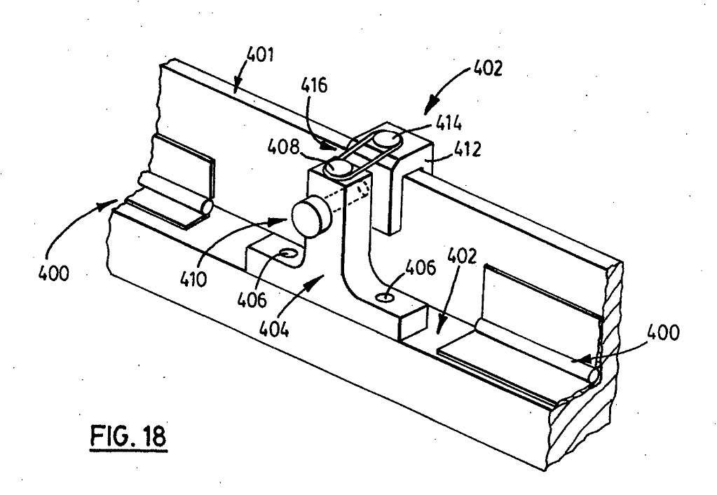

Although the apparatuses have been described as including generally planar mirrors that are affixed to brackets by adhesive to maintain their desired orientations, other designs to reflect backlight illumination towards the active pixel sub-array of the imaging device are of course possible. For example, if desired, each mirror 401 may be connected to one side of the frame 402 via a pair of piano-type hinges 400 as shown in FIG. 18. In this example, a mirror adjustment mechanism 402 acts between the frame and the mirror and is generally centrally mounted on the side of the frame between the hinges 400. The mirror adjustment mechanism includes a mounting fixture 404 secured to the frame by suitable fasteners 406. A retaining post 408 extends upwardly from the top of the mounting fixture 404. A fine pitch screw 410 engages a threaded hole provided through the mounting fixture 404 and can be rotated to alter the distance by which the distal end of the screw 410 extends beyond the mounting fixture 404 towards the mirror. A bracket 412 engages the top of the mirror at a location in line with the screw 410. A second retaining post 414 extends upwardly from the top of the bracket 412. A biasing element 416 in the form of a loop of elastic cord or other suitable material engages the retaining posts 408 and 414 to bias the mirror so that the bracket remains in contact with the screw 410. Alternatively, the biasing element may take the form of a spring or other resilient element that urges the mirror toward the mounting fixture 404. During mirror alignment, the screw 410 is rotated in the appropriate direction either to tilt the mirror towards or away from the imaging device until the backlight illumination reflected by the mirror is directed towards the active pixel sub-array. The biasing element 416 acting between the bracket 412 and the mounting fixture 404 inhibits the mirror from moving once the mirror is in the desired orientation.

In a further embodiment, rather than using planar mirrors, curved mirrors can be used. In this case, the reflective surfaces of the mirrors are generally convex so that the bands of backlight illumination provided by the illuminated bezels when reflected by the mirrors are directed towards the active pixel sub-array of the imaging device. Curving the mirrors increases the fields of view of the mirrors and hence, reduces mounting tolerances. In this embodiment, the mirrors have a radius of curvature equal to approximately 100 inches. The radius of curvature of the mirrors and the height of the infrared illuminated bezels are selected so that at least ½ inch of the pointer tip is illuminated by reflected infrared backlighting when the pointer is in the region of interest and is in contact with the touch surface.

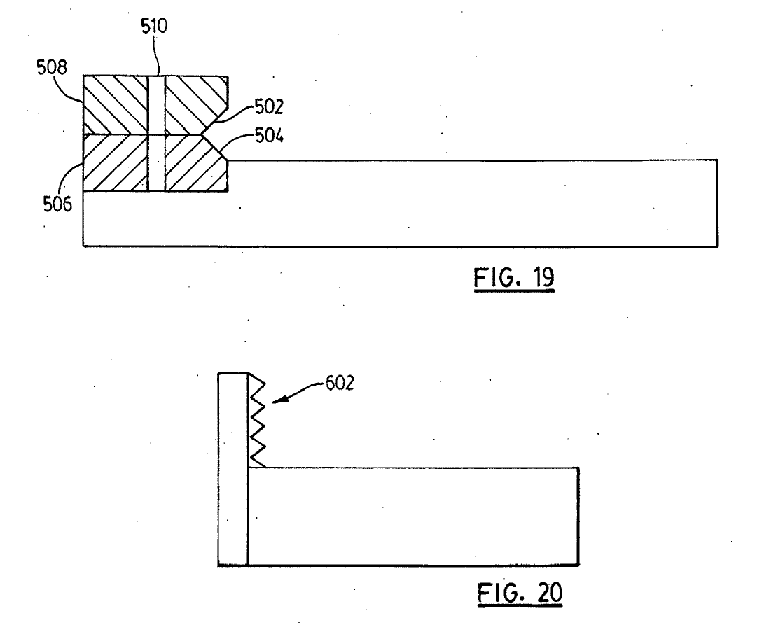

In yet another embodiment, the mirrors may include a pair of reflective surfaces 502 and 504 arranged 90 degrees with respect to one another to form a V-configuration as shown in FIG. 19. As can be seen, each mirror is formed from a pair of stacked trapezoidal metal pieces 506 and 508, in this case aluminum, each having a polished highly reflective surface. The metal pieces carry mating formations such as locating pins 510 and complimentary holes to position accurately the metal pieces relative to one another and to locate the mirrors on the frame.

In still yet another embodiment, the mirrors may include corrugated reflective surfaces 602 defined by stacked pairs of reflective surfaces arranged 90 degrees with respect to one another as shown schematically in FIG. 20. In this case, each mirror is formed of a block of acrylic material having one surface that is compression molded to define a corrugated surface including a series of stacked V-grooves such as that manufactured by Fresnel Optics under model number PR713. A reflective coating is applied to the corrugated surface by sputtering or other suitable technique. The mirror is positioned on the frame with the corrugated reflective surface nearest the imaging device. Alternatively, the mirror may be positioned on the frame with the corrugated reflective surface furthest from the imaging device. In this case, the backlight illumination enters and travels through the block of material before being reflected back by the corrugated reflective surface.

Although the gap has been shown and described as extending along two sides of the region of interest, those of skill in the art will appreciate that the non-reflective region associated with the gap need only extend along one side of the region of interest to inhibit the double pointer reflection from occurring when the pointer is adjacent the corner 32. Also, although the non-reflective region is shown as a gap between the mirrors 24 and 26, if the mirrors join at the corner 32, the mirrors can be rendered non-reflective at the corner 32 using a suitable coating or covering to define the non-reflective region.

Turning now to FIG. 21, yet another embodiment of an apparatus for detecting a pointer within a region of interest is shown and is identified by reference numeral 710. In this embodiment, only a single mirror 724 is provided along one side of the region of interest. The remaining sides are coated with a high contrast material 742, in this case a black matte paint or felt. Similar to the embodiment of FIGS. 16 and 17, infrared LEDs (not shown) are positioned adjacent the imaging device 722 and direct infrared light into the region of interest. Since only one mirror is utilized in this embodiment, fewer images of the pointer appear in captured images although sufficient pointer images appear in order to triangulate the position of the pointer. Also, since only one mirror is utilized, an L-shaped margin extending along two sides of the active area 734 is required to inhibit pointer image merging.

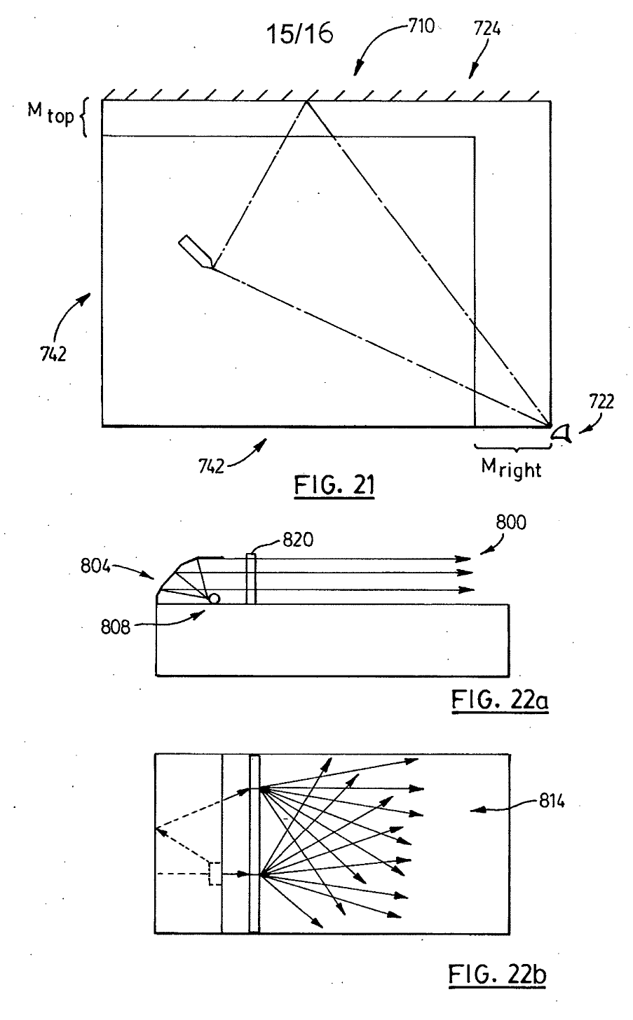

FIGS. 22a and 22b show an alternative illuminated bezel generally identified by reference numeral 800. As can be seen, in this embodiment the illuminated bezel 800 comprises a parabolic collimator 804 formed on an internal bezel surface that reflects light from an LED 808 back across the touch surface 814 on paths generally parallel to the touch surface 814. A lenticular array 820 positioned between the touch surface 814 and the collimator 804 disperses the light reflected by the collimator 804 across the touch surface 814. The lenticular array 820 can, for example, have a number of facets that redirect light within a horizontal plane above the touch surface 814, while preserving its vertical component to ensure that the light travels generally across the touch surface 814 and not away from or towards it. By redirecting a significant portion of the light from the LED 808 across the touch surface 814, a greater intensity of light is viewed by the imaging device, thus providing better resolution in the images captured. As seen in FIG. 22b, by positioning the LED 808 a significant distance from the collimator 804, light is dispersed over a broad area by the lenticular array 820. In this manner, the touch surface 814 is illuminated relatively evenly using a limited number of light sources. The collimator and lenticular array may be combined into a dual-sided thin film placed in between the LED and the region of interest.

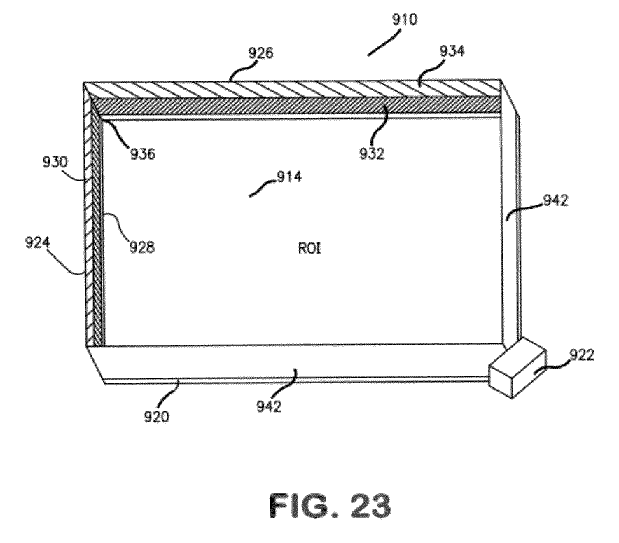

Turning now to FIG. 23, still yet another embodiment of an apparatus for determining the location of a pointer within a region of interest is shown and is identified by reference numeral 910. In this embodiment, similar to that of FIGS. 1 to 3, apparatus 910 is in the form of an interactive input system and is disposed over the display screen of a display unit such as for example, a plasma television, a liquid crystal display (LCD) panel, a front or rear projection screen or other suitable display unit (not shown). As can be seen, apparatus 910 comprises a generally rectangular assembly 912 encompassing a region of interest ROI and surrounding a generally transparent touch surface 914 that overlies the display screen. Assembly 912 communicates with a general purpose computing device 916 such as for example a personal computer executing one or more application programs. The general purpose computing device 916 uses pointer data generated by the assembly 912 to update computer-generated images that are presented on the display screen by the display unit. Pointer contacts on the touch surface 914 can therefore be recorded as writing or drawing or used to control execution of application programs executed by the general purpose computing device 916.

Assembly 912 comprises a frame 920 supporting an imaging device 922 adjacent one corner of the touch surface 914. The imaging device 922 has a field of view that looks generally across the plane of the touch surface 914 and is oriented so that its optical axis generally forms a 45 degree angle with adjacent sides of the touch surface 914.

A pair of reflective elements 924 and 926 is also supported by the frame 920. Each reflective element 924 and 926 extends along a different side of the touch surface 914 and is oriented such that the plane of its reflecting surface is generally perpendicular to the plane of the touch surface 914. The reflective elements 924 and 926 are thus arranged at generally a 90 degree angle with respect to one another and intersect at a corner 936 of the touch surface 914 diagonally opposite from imaging device 922.

In this embodiment, the reflecting surface of reflective element 924 comprises a pair of generally parallel bands or strips that extend the length of the reflective element 924. In particular, the reflective surface of reflective element 924 comprises a retro-reflective band 928 that is positioned furthest from the touch surface 914 and a reflective band 930 below the retro-reflective band 928 nearest the touch surface. Similarly, the reflecting surface of reflective element 926 comprises a pair of generally parallel bands or strips that extend the length of the reflective element. In particular, the reflective surface of reflective element 926 comprises a retro-reflective band 932 that is positioned furthest from the touch surface 914 and a reflective band 934 below the retro-reflective band 932 nearest the touch surface.

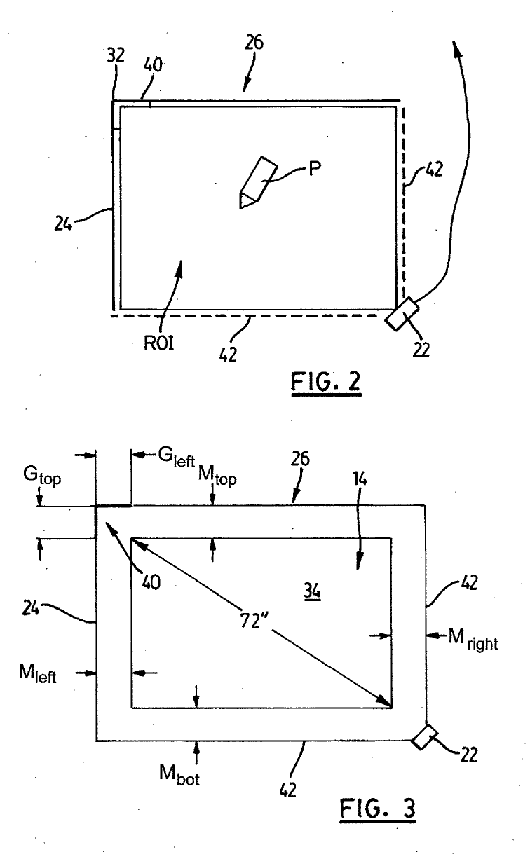

The frame 920 also supports retro-reflective bezels 942 extending along the remaining two sides of the touch surface 914, one on either side of the imaging device 922. The retro-reflective bezels 942 reflect incident light back substantially in the impingent direction and thus, effectively act as illuminated bezels similar to those shown in FIG. 2.

Positioned adjacent to the imaging device 922 is an infrared illumination source 923 such as, for example, one or more infrared LEDs, that direct infrared (IR) light towards the reflective elements 924 and 926. The retro-reflective bands 928 and 932 of the reflective elements 924 and 926 re-direct the IR light back towards the imaging device 922 while the reflective bands 930 and 934 of the reflective elements 924 and 926 scatter the IR light. Some of the scattered IR light impinges on the retro-reflective bezels 942 where it is returned to the reflective bands 930 and 934 and reflected back towards the imaging device 922.

Each reflective element 924, 926 is supported on the frame 920 by a right angle extruded bracket, similar to that described above with reference to FIG. 4. The reflective surfaces of the reflective elements 924 and 926 are generally planar and are oriented so that some of the scattered IR light, whether directly impinging thereon or returning from the retro-reflective bezels 942, is directed towards an active pixel sub-array of the imaging device 922. Orienting the reflective elements 924 and 926 in this manner maintains the resolution of the apparatus 910 allowing pointer hover and pointer contact with the touch surface 914 to be accurately determined. To align the reflective elements 924 and 926, during assembly, adhesive is placed along the leg of each bracket and the reflective elements 924 and 926 are set in place. While the adhesive is setting, the tilt of each reflective element is adjusted until the infrared light reflected by each reflective band 930 and 934 is directed toward the active pixel sub-array of the imaging device 922. Once the adhesive sets, the reflective elements 924 and 926 are securely held by the adhesive thereby to maintain their orientation.

The imaging device 922 is similar to imaging device 22 described above. Accordingly, specifics will not be described further.

During use, infrared light emitted by the illumination source 923 is redirected by the retro-reflective bands 928 and 932 of the reflective elements 924 and 926, back towards the imaging device 922. Infrared light emitted by the illumination source 923 is also scattered by the reflective bands 930 and 934 of the reflective elements 924 and 926. As mentioned above, some of the scattered infrared light is returned to the imaging device while some of the scattered infrared light impinges on the retro-reflective bezels 942. The scattered infrared light that impinges on the retro-reflective bezels 942 is returned to the reflective bands 930 and 934 where it is reflected back towards the imaging device 922. Thus, in the event no pointer P is positioned within the region of interest ROI, the imaging device 922 observes a generally continuous white or bright band of infrared illumination. The white or bright band is comprised of two components, one component representing infrared light re-directed by the retro-reflective bands 928 and 932 directly back to the imaging device 922 and one component representing infrared light scattered by the reflective bands 930 and 934, whether directly impinging thereon or returning from the retro-reflective bezels 942.

When a pointer P is brought into the region of interest ROI and therefore, into the field of view of the imaging device 922, the pointer P occludes infrared illumination. Thus, when the imaging device captures an image, the pointer P appears as a dark spot against a white background representing the true pointer in the component representing infrared light re-directed by the retro-reflective bands 928 and 932. The pointer P also appears as multiple dark spots representing the true pointer location and the pointer reflections in the component representing infrared light scattered by the reflective bands 930 and 934, whether directly impinging thereon or returning from the retro-reflective bezels 942. The true pointer location can be distinguished from the pointer reflections since only the true pointer location is captured against the retro-reflective bands 928 and 932. The pointer location can then be calculated using triangulation as described above.

Because the true pointer location can always be distinguished from the image of the pointer on the retro-reflective bands 928 and 932, there is no requirement for a gap between the reflective elements 924 and 926 in order to resolve the double pointer reflection P_{D} when the pointer P is near the corner 936. Further, there is no requirement for a margin surrounding the touch surface 914 in order to resolve merged pointers if the pointer gets too close to the reflective bands 930 and 934, imaging device 922 or diagonal vertex. As will be appreciated, this simplifies the calculation to determine the location of the pointer P relative to the touch surface 914.

As will be appreciated, the bands of the reflective elements 924 and 926 could be arranged such that the reflective bands 930 and 934 are positioned farthest from the touch surface 914, and the retro-reflective bands 928 and 932 are positioned closest to the touch surface 914.

Although the reflective elements 924 and 926 are described as having two separate reflective and retro-reflective bands separately adhered to a bracket, those skilled in the art will appreciate that the reflective elements may be made of a single reflective band. In this embodiment, the single reflective band may be a mirror and the mirror could be partially coated by a retro-reflective covering thus defining a retro-reflective band on part of the reflective band.

In another embodiment, the reflective bands 924 and 926 may be covered with polarizers and the infrared illuminated bezels may be polarized such that double pointer reflections could be attenuated allowing image processing to be further simplified.

In another embodiment the retro-reflective bezels 942 may be infrared illuminated bezels, thereby eliminating the need for an illumination source positioned adjacent to the imaging device. Further, the illuminated bezels could be modulated differently from one another such that the direct reflections could be separated from the double reflections.

In yet another embodiment, two imaging devices may be used and mounted on adjacent corners of a first side of the frame. In this embodiment, a first reflective element, similar to reflective element 924 described above, extends along a second side of the frame opposite the two imaging devices. Retro-reflective bezels, similar to retro-reflective bezels 942 described above, extend along the first side, a third side, and a fourth side of the frame. An infrared light source is positioned adjacent to each one of the imaging devices, providing infrared illumination to the region of interest. This creates an interactive input system that is two (2) times as large with virtual cameras at each of its corners. The combination of retro-reflective bezels with the reflective element reflecting the illumination emitted by each light source provides a generally continuous bright band of infrared illumination observed by the imaging devices when no pointer is within the field of view of the imaging devices. When a pointer is brought into the region of interest, and therefore, into the field of view of each of the imaging devices, the pointer occludes the continuous bright band of light observed by each imaging device. As such, the pointer appears as a dark spot against a white background representing the true pointer location. Since two imaging devices are used, the location of the pointer can be calculated using triangulation. In another embodiment, rather than emitting infrared illumination, it will be appreciated that the light sources may emit any spectrum of light such as for example visible light. In yet another embodiment, the retro-reflective bezels may be replaced by illuminated bezels, thereby eliminating the need for a light source positioned adjacent each imaging device.

The digital camera is described as being mounted on a circuit board and positioned so that its field of view looks generally across the plane of the touch surface. As will be appreciated, the circuit board can of course be located at different locations. In this case, folding optics are used to aim the field of view of the digital camera across the plane of the touch surface. As will also be appreciated a variety of different types of imaging devices can be used to capture images such as for example CCD sensors and line arrays. If desired, the surface of the display unit may be used as the touch surface.

Although embodiments have been described with particular reference to the figures, those of skill in the art will appreciate that variations and modifications may be made without departing from the scope thereof as defined by the appended claims.

What is claimed is:

1. An apparatus for detecting a pointer within a region of interest comprising:
a first reflective element extending along a first side of said region of interest and reflecting light towards said region of interest, said first reflective element comprising at least two generally parallel bands thereon, said bands at least comprising a retro-reflective band and a reflective band;
a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band;
at least one imaging device capturing images of said region of interest including reflections from the reflective and retro-reflective bands of said first and second reflective elements; and
at least one illumination source positioned adjacent to said at least one imaging device, said at least one illumination source directing light across said region of interest towards said first and second reflective elements.

2. The apparatus of claim 1 further comprising processing structure for processing said captured images to determine the location of the pointer within the region of interest.

3. The apparatus of claim 1 wherein said first and second reflective elements extend along first and second sides of a generally rectangular touch surface.

4. An apparatus according to claim 1 wherein said first and second reflective elements are arranged generally at right angles to one another.

5. The apparatus of claim 4 wherein the planes of said first and second reflective elements are oriented generally perpendicular to the plane of said region of interest.

6. The apparatus of claim 5 wherein the retro-reflective band of each of said first and second reflective elements extends along the length of the respective first and second sides of the region of interest.

7. The apparatus of claim 6 wherein the retro-reflective band of each of said first and second reflective elements is positioned closest to said region of interest, and the reflective band of said first and second reflective elements is positioned above the retro-reflective band.

8. The apparatus of claim 6 wherein the reflective band of each of the first and second reflective elements is positioned closest to said region of interest, and the retro-reflective band of the first and second reflective elements is positioned about the reflective band.

9. The apparatus of claim 1 comprising a single imaging device.

10. The apparatus of claim 9 wherein said imaging device looks across said region of interest from a second corner thereof diagonally opposite said first corner.

11. The apparatus of claim 10 wherein said imaging device comprises an image sensor having an active pixel sub-array, light reflected by said first and second reflective elements being directed towards said active pixel sub-array.

12. The apparatus of claim 11 further comprising retro-reflective bezels extending along third and fourth sides of said region of interest.

13. The apparatus of claim 1 wherein said illumination source is an infrared illumination source.

14. The apparatus of claim 11 comprising illuminated bezels extending along third and fourth sides of said region of interest, said illuminated bezels directing light towards said first and second reflective elements.

15. The apparatus of claim 14 wherein said illuminated bezels are infrared illuminated bezels.

16. The apparatus of claim 15 wherein the reflective bands of said first and second reflective elements are covered with polarizers and said infrared illuminated bezels are polarized.

17. The apparatus of claim 16 wherein said infrared illuminated bezels are modulated to different frequencies with respect to one another.

18. An apparatus for detecting a pointer within a region of interest comprising:
a first reflective element extending along a first side of said region of interest and reflecting light towards said region of interest, said first reflective element comprising at least two generally parallel bands thereon, said bands at least comprising a retro-reflective band and a reflective band;
a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band;
at least one imaging device capturing images of said region of interest and reflections from said first and second reflective elements, said at least one imaging device having an active pixel sub-array and said first and second reflective elements being configured to aim reflected light towards said active pixel sub-array; and
at least one illumination source positioned adjacent to said at least one imaging device, said at least one illumination source directing light across said region of interest and towards said first and second reflective elements.

19. The apparatus of claim 18 wherein said first and second reflective elements are angled relative to said region of interest to aim reflected light towards said active pixel sub-array.

20. The apparatus of claim 18 further comprising processing structure for processing said captured images to determine the location of the pointer within the region of interest.

21. An apparatus for detecting a pointer within a region of interest comprising:
a generally rectangular touch surface defining said region of interest;
a first reflective element extending along a first side of said region of interest and reflecting light towards said region of interest, said first reflective element comprising at least two generally parallel bands thereon, said bands at least comprising a retro-reflective band and a reflective band;
a second reflective element extending along a second side of said region of interest and reflecting light towards said region of interest, said second side being joined to said first side to define a first corner, said second reflecting element comprising at least two generally parallel bands thereon, said bands at least comprising a retro-reflective band and a reflective band;
a detecting device detecting said pointer within said region of interest contrasting with a background provided by the retro-reflective bands of said first and second reflective elements, the detecting device also detecting said pointer and reflections of said pointer contrasting with a background provided by the reflective bands of said first and second reflective elements, and determining the location of said pointer within said region of interest; and
at least one illumination source positioned adjacent said to said detecting device, said at least one illumination source directing light across said region of interest and towards said first and second reflective elements.

22. The apparatus according to claim 21 wherein said detecting device looks across said touch surface from a second corner thereof diagonally opposite said first corner.

23. The apparatus according to claim 21 wherein said detecting device includes an image sensor having an active pixel sub-array, light reflected by said first and second reflective elements being directed towards said active pixel sub-array.

24. The apparatus according to claim 23 wherein said first and second reflective elements are configured to aim reflected light towards said active pixel sub-array.

25. The apparatus according to claim 24 wherein said first and second reflective elements are angled relative to said touch surface to aim reflected light towards said pixel sub-array.

26. The apparatus of claim 21 wherein said illumination source is an infrared illumination source.

27. The apparatus of claim 25 comprising retro-reflective bezels extending along a third and fourth side of said region of interest.

28. The apparatus of claim 25 comprising illuminated bezels extending along a third and fourth side of said region of interest, said illuminated bezels directing light towards said first and second reflective elements.

29. The apparatus of claim 28 wherein said illuminated bezels are infrared illuminated bezels.

30. The apparatus of claim 29 wherein the reflective bands of said first and second reflective elements are covered with polarizers and said infrared illuminated bezels are polarized.

31. The apparatus of claim 29 wherein said infrared illuminated bezels are modulated to different frequencies with respect to one another.

32. The apparatus of claim 23 further comprising processing structure for processing said captured images to determine the location of the pointer within the region of interest.

33. An apparatus for detecting a pointer within a region of interest comprising:
a first reflective element extending along a first side of said region of interest and reflecting light towards said region of interest, said first reflective element comprising at least two generally parallel bands thereon, said bands at least comprising a retro-reflective band and a reflective band;
at least two imaging devices positioned adjacent to opposing corners of a second side of said region of interest, said second side opposite said first side, said at least two imaging devices capturing images of said region of interest including reflections from the reflective and retro-reflective bands of said first reflective element; and
at least two illumination sources directing light across said region of interest towards said first reflective element.

34. The apparatus of claim 33 wherein said at least two illumination sources are infrared illumination sources.

35. The apparatus of claim 33 wherein each one of said at least two illumination sources is positioned adjacent to a respective one of said at least two imaging devices.

36. The apparatus of claim 35 comprising retro-reflective bezels extending along said second side, a third side, and a fourth side of said region of interest.

37. The apparatus of claim 33 wherein said at least two illumination sources is three illumination sources.

38. The apparatus of claim 37 wherein said three illumination sources are infrared illuminated bezels extending along said second side, a third side, and a fourth side of said region of interest.

39. The apparatus of claim 33 further comprising processing structure for processing said captured images to determine the location of the pointer within the region of interest.
